(19) United States
(12) Patent Application Publication
(10) Pub. No.: US 2019/0337821 A1
(43) Pub. Date: Nov. 7, 2019

(54) Safe Long-Lasting Algae Control For Ornamental Water Features

(71) Applicant: Dennis B. Jenkins, Brentwood, CA (US)

(72) Inventor: Dennis B. Jenkins, Brentwood, CA (US)

(21) Appl. No.: 15/973,440

(22) Filed: May 7, 2018

(51) Int. Cl. C02F 1/28; B01J 20/08

(52) U.S. Cl. CPC C02F 1/28; B01J 20/08; C02F 2101/22; C02F 1/281; C02F 1/288; C02F 1/283

(57) ABSTRACT

Safety is one of the most desired attributes of an algae control agent for ornamental water features, since the water is often consumed by wildlife and pets, and children sometimes come in contact with the water. The present invention safely prevents the growth of algae in ornamental water features, and does not add chemicals to the water, but controls algae by using insoluble adsorbents to remove essential micronutrients necessary for algal growth. The invention can be used in still or recirculating water features of all types, including bird baths, water fountains, artificial streams, ornamental waterfalls, and small ponds. Since no compounds are being released into the water, the algae control is very long-lasting, and is also maintenance-free, with no action necessary on the part of the user even when evaporation or removal of debris requires refilling the feature.

### CROSS-REFERENCE TO RELATED APPLICATIONS

This application claims the benefit of Provisional Application 62/502,777, filed on May 8, 2017, entitled “Safe Long-Lasting Algae Control for Ornamental Water Features”, and is incorporated by reference herein in its entirety.

### FIELD OF THE INVENTION

The present invention relates to a method and system for safely preventing or inhibiting the growth of algae in ornamental water features by using solid adsorbents to reduce essential micronutrients necessary for algal growth. Safety is one of the most desired attributes of an algae control agent for ornamental water features, since children sometimes come in contact with the water, and the water is regularly consumed by wildlife and pets. Since the invention uses solid insoluble materials to achieve the reduction of micronutrients, no compounds are released into the water, and the water is inherently safe for drinking by wildlife and pets. The solid adsorbents used have high-surface-area and surface adsorption sites which trap transition metal micronutrients, making the water micronutrient-poor, inhibiting algal growth. The invention can be used in still or recirculating water features of all types, including bird baths, water fountains, artificial streams, ornamental waterfalls, and small ponds. Since no compounds are being added or released into the water, the algae control provided by the invention is very long-lasting. It is also maintenance-free, with no action necessary on the part of the user even when evaporation or removal of debris requires refilling the feature.

### BACKGROUND OF THE INVENTION

Water features such as bird baths and water fountains are attractive additions to a yard and can also function to help attract wild birds. Unfortunately, these features also promote the growth of natural microorganisms such as algae, and demand frequent cleaning or the use of an antimicrobial control.

One of the problems with using an antimicrobial algae control additive, is that wildlife and pets commonly drink from water features, and children commonly come in contact with the features . Some antimicrobial algae additives, such as hypochlorite bleach, are not safe for animals and children to contact, and definitely not safe to drink. Copper salts can be used to control algae, but are used at higher levels than desired for drinking water. Other antimicrobial additives such as chelated or metalorganic compounds, are not natural, and have questionable safety. Quaternary antimicrobials and chelating agents also have questionable safety. Others, such as enzymes have questionable performance, and need to be continually added, and still may not be recommended as a drinking source for all animals.

A second problem is that algae control additives may not last very long. Chlorine converts quickly to sodium chloride, and must be continually re-added. Others break down or are used up, and their effectiveness fades with time.

A third problem is that existing algae control additives need to be re-added every time the feature is cleaned or refilled with water. This is inconvenient and costly for the consumer.

What is needed is a method to control algae and other microorganisms, which is long-lasting, does not need to be re-added when the feature is cleaned and refilled, and is inherently safe for wildlife, pets, and children.

### SUMMARY OF THE INVENTION

We have surprisingly discovered a safe and long-lasting method and system for inhibiting and preventing algae in ornamental water features, by using insoluble adsorbents to remove transition metal micronutrients that algae need to grow. The invention uses high-surface-area compounds which contain binding sites to remove transition metal micronutrients from the water, making it depleted in transition metal micronutrients, preventing algae from growing.

Safety is one major advantage of the present invention over other inventions. Since the present invention uses solid insoluble compounds to achieve the algae control, no compounds are released into the water, and the water is inherently safe for drinking by wildlife and pets, and safe for children to contact.

Long-lasting performance is another advantage of the present invention over other inventions. Because there are no compounds to be consumed, one is able to continually and sustainably remove micronutrients and continually prevent their growth over a long period.

Low-maintenance is another advantage of the present invention over other inventions. Since these adsorbing compounds can be formed into solid objects, they do not need to be filtered or removed from the water during maintenance and cleaning. This makes preventing algal growth in a water feature virtually maintenance free.

The invention can be used in still or recirculating water features of all types, including bird baths, water fountains, artificial streams, ornamental waterfalls, and small ponds . This same invention can also be used for non-ornamental closed-loop water systems, both static and recirculating.

The invention describes the reduction of any transition metal micronutrient to inhibit or prevent the growth of algae. A substantial reduction of one essential micronutrient even if needed at very low levels, can inhibit or prevent the growth of algae. One embodiment of the invention is the reduction of one or more micronutrient metals in the D-block of the periodic table to inhibit or prevent the growth of algae. Also, since several species of algae may be present, the invention also describes the reduction of several micronutrients, intended to inhibit or prevent the growth of one algae or several different algae species.

Some micronutrients are needed by algae at higher levels than others. One embodiment of the invention is the reduction of transition elements from the 4th row of the D-block in the periodic table to inhibit or prevent the growth of algae. One embodiment of the invention, is the reduction of one or more of the elements chromium, manganese, iron, cobalt, nickel, copper, zinc, and molybdenum to inhibit or prevent the growth of algae. One embodiment of the invention is the reduction of one or more of the elements manganese, iron, nickel, and molybdenum to inhibit or prevent the growth of algae. One embodiment of the invention, is the reduction of nickel to inhibit or prevent the growth of algae. One embodiment of the invention, is the reduction of manganese to inhibit or prevent the growth of algae. One embodiment of the invention, is the reduction of molybdenum to inhibit or prevent the growth of algae. One embodiment of the invention, is the reduction of iron to inhibit or prevent the growth of algae.

One can attempt to use macronutrients to create a nutrient deficiency for algae. For example, depriving algae of macronutrients such as nitrogen, potassium or phosphorous may also limit growth. However micronutrients and especially the transition metals have advantages that the other macronutrients don't. If macronutrients were the target of reduction, some issues are: 1) because of the greater quantity of the macronutrients naturally present, a greater quantity of molecules need to be adsorbed, requiring greater amounts of adsorbent, 2) the macronutrients are more common in nature and in the dust and bird waste that may fall into the feature, so they are constantly being re-introduced into the feature at a greater rate than the micronutirents; and 3) many of the macronutrients do not bind as strongly with adsorbents, and therefore are not completely removed from the system. Since micronutirents 1) occur in lower concentrations in nature, and 2) generally have greater affinity of adsorption, we can conclude that using transition metal micronutrients to control algal growth is a separate and superior strategy to using macronutrients to control algae.

The invention can be practiced in many physical forms. The adsorbent can be placed into the ornamental water feature alone without any additional packaging or enclosure. For example the adsorbent combined with bonding materials can be manufactured into a porous form shaped and colored like an animal to sit at the bottom of a bird bath. Or, if the adsorbent is granular material, it can be easily added or removed from the feature by constraining it within a permeable enclosure. Any enclosure should be permeable for water to exchange between the adsorbent and the water exterior to the enclosure. The enclosure can be of made in various styles and types, constructed from multiple types of materials. For example the adsorbent can be enclosed within a mesh bag, a plastic container with holes, a plastic container made from plastic mesh, or a decorative container with holes. Examples of decorative containers are a shell shape, heart shape, or a turtle shape. The adsorbent can also be enclosed in a floating permeable container, for example a plastic fish, duck or other animal which freely floats around the surface of the water in a fountain. Or it can be physically bonded to the outside of another functional or decorative object to hold it in place in the water feature.

In addition to preventing the growth of algae, under the proper circumstances the present invention can also be used to kill existing algal growth by starving it of micronutrients. If algae is already growing, depleting the water of micronutrients has been shown to stop and then kill the existing growth.

The length of time that algae is inhibited or prevented will vary due to a number of factors, for example water temperature, amount of additional water added, chemistry of the water, amount of foreign material that enters the feature, and the amount of adsorbent used. Since after some extended time period the algae may grow back, we can also describe the invention as inhibiting the growth of algae, mitigating the growth of algae, repressing the growth of algae, or other similar terms.

### BRIEF DESCRIPTION OF THE DRAWINGS

FIG. 1-A is a representative drawing showing a powdered form of the insoluble adsorbent used for control of algae as described in the present invention.

FIG. 1-B is a representative drawing showing a granular form of the insoluble adsorbent used for control of algae as described in the present invention.

FIG. 1-C is a representative drawing showing a large granular form of the insoluble adsorbent used for control of algae as described in the present invention.

FIG. 1-D is a representative drawing showing a cross section of the granular form of the insoluble adsorbent enclosed in a flexible water-permeable mesh sack, used for control of algae as described in the present invention. The mesh sack could sit on the bottom of the feature, or hang from any area in the body of water of the feature.

FIG. 1-E is a representative drawing showing the granular form of the insoluble adsorbent enclosed in a rigid water-permeable container, possessing holes for water transfer, used for control of algae as described in the present invention.

FIG. 1-F is a representative drawing showing the granular form of the insoluble adsorbent enclosed in a rigid water-permeable container, possessing plastic mesh for water transfer, used for control of algae as described in the present invention.

FIG. 1-G is a representative drawing showing a solid block of the insoluble adsorbent used for control of algae as described in the present invention, containing holes to increase the outside surface and increase the surface contact with the water. In one embodiment of the invention, the solid block could be comprised of smaller particles of adsorbent bonded together.

FIG. 1-H is a representative drawing showing a solid form of the insoluble adsorbent, bonded together in a decorative pattern, used for control of algae as described in the present invention. The form contains holes to increase the outside surface and increase the surface contact with the water. In one embodiment of the invention, the solid block could be comprised of smaller particles of adsorbent bonded together.

FIG. 1-I is a representative drawing showing a granular form of the adsorbent attached to the outside of a decorative item, used for control of algae as described in the present invention. In one embodiment of the invention, the decorative item could be placed on the bottom of the body of water of the feature.

FIG. 1-J is a representative drawing showing a decorative enclosure for the insoluble adsorbent in the shape of a fish, used for control of algae as described in the present invention. The enclosure contains trapped air or low density material for buoyancy to allow the decorative device to freely float on the upper part of the body of water, and holes or mesh allow the device to exchange water with the adsorbent.

FIG. 2-A is a representative drawing showing use of the adsorbent material and enclosures in a representative type of water feature, used for control of algae as described in the present invention.

FIG. 3-A is a representative drawing showing use of the adsorbent material and enclosures in another representative type of water feature, used for control of algae as described in the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “indicating agent” includes two or more such agents.

Unless defined otherwise, all technical and scientific terms used herein have the same meaning as commonly understood by one of ordinary skill in the art to which the invention pertains.

Definition of Terms:

Algae: Algae refers to any one of many types of photosynthetic organisms that are often found in aquatic environments. These organisms typically use photosynthesis, and can grow in sea, freshwater, and even moist environments on land. No definition of algae is generally accepted, but for the purposes of the specifications and claims, algae are photosynthetic organisms that grow readily in freshwater ornamental water features. Some commonly encountered types of freshwater algae are green algae, red algae, brown algae, black algae, and diatoms. Algae even includes photosynthetic bacteria, such as blue-green algae. If left unchecked, algae can produce toxins harmful to both human and animal life.

Preventing Algae Growth: In an optimum application of the method, system or kit, the present invention has the ability to prevent algae from growing, or even kill algae present. But many conditions of actual use may result in inhibition, mitigation, or repression of growth, rather than complete cessation of growth. In addition to describing the present invention as “preventing the growth of algae”, or“controlling the growth of algae”, we are also including within the present invention the inhibition, mitigation, or repression of the growth of algae.

Ornamental Water Feature: An ornamental water feature refers to a structure that is designed to contain water while also providing an attractive and decorative visual appearance. The water in these structures can be static, recirculating, or freely moving. These can be in ground or above ground. Examples are a fountain, birdbath, pond, artificial stream, ornamental waterfall, reflecting pool, plunge pool, water falls, water wall, water stair, water ramp, water folly, or stream garden.

Bird Bath: A bird bath is a man-made structure capable of holding water that birds may use to wash themselves. A bird bath typically consists of one or more basins that are supported by a column or pedestal but can also be a hanging fixture, or may even located directly on the ground. The bird bath can be filled with water artificially or through rainfall.

Fountain: A fountain is a piece of architecture that circulates or projects liquid, typically water, through one or more basins. They are generally decorative, and provide visual appeal, but can serve other purposes such as white noise, meditation focus, water aeration, and drinking water for birds or other animals. They can be located both indoors or outdoors. Examples are a wall fountain, tabletop fountain, spitter fountain, or bubbler fountain.

Adsorption: Adsorption is the process by which atoms, ions, or molecules from a gas or liquid, are adhered to another surface in such a way as to remove them from a source material and contain them on the surface of a destination material. This process creates a film of the adsorbate on the external and internal surface of the adsorbent. Adsorption is a surface-based process. Adsorption can occur by the mechanism of physisorption or chemisorption.

Adsorbent: An adsorbent is a compound whose internal and/or external surfaces possesses the ability for adsorption. Generally adsorbents have high surface area, and can also have charge deficiencies or edge sites that allow for strong bonding between the structure and the adsorbing elements. Some examples of adsorbing compounds are a) metal oxides and metal hydroxides such as activated alumina, activated bauxite, aluminum hydroxide, smectite clay, natural zeolite, synthetic zeolite, silica gel, precipitated silica, fumed silica, iron hydroxide, and manganese oxide; b) carbon, such as, activated carbon; c) polymers such as polymeric molecular sieves; and d) hybrid material such as metal organic framework (MOF) and metal-organic polyhedral (MOP). These are broad categories, and the sub-categories of each adsorbent are understood to be included in the invention. For example, specific compounds under activated alumina, are all the different phases of alumina: gamma alumina, alpha alumina, chi alumina, kappa alumina, eta alumina, rho alumina, delta alumina, and theta alumina.

Insoluble adsorbent: A material that does not dissolve in water in any significant way, and also has the properties of adsorption. The term insoluble is often applied to very poorly soluble compounds, a common threshold being less than 0.1 g per 100 mL of water. However the insoluble adsorbents cited in the present invention are generally much less soluble than this threshold.

Micronutrients: Micronutrients are compounds required in small quantities by organisms throughout life in order to facilitate a range of vital physiological functions. These compounds are not able to be naturally synthesized by the body, and therefore must be obtained from an outside source, whether natural or artificial. Examples of essential micronutrients can include iron, cobalt, chromium, copper, iodine, manganese, selenium, zinc, and molybdenum. These compounds are naturally found in all types of water at trace levels and are required to sustain plant and animal life in these waters.

Transition Metal: Transition metals are compounds comprised of a elements from the d-block of the periodic. Transition metal cations include among others, chromium, cobalt, copper, zinc, manganese, molybdenum, and iron. Transition metal cations can occur in several different valance states. In nature, and in the use of the present invention, transition metals are likely to occur in an oxidized state as free cations or cations within a salt. If occurring as a salt, the metal can be non-dissociated or dissociated. However, some metals can also occur in the reduced state or as covalently bonded oxides.

Surface Area: Surface area or specific surface area, is the total external and internal surface of a material per weight of the material. The measurement is reported as area per unit of mass, usually square meters per gram.

Metal Binding Site Density: Adsorption of metals from solution on to a solid surface is due to a number of factors such as surface area, number of charge deficiencies per volume, pore volume, pore size, number of edge sites, and others. The binding site density will be different for different metals, and will change with deviations away from pH neutrality. For this document we are defining the term metal binding site density, to mean the estimated amount of potential chemisorption or physisorption sites that a material may have at pH 7.

Functional Materials: Functional materials that may further be combined with the present inventive compositions include coloring agents, anti-caking agents and binding agents. Additional functional materials include, but are not limited to vitamins, anti-microbial agents, anti-molding agents, odor absorbers, spoilage indicators, flavorants, and fragrance. The functional materials may be present in any desirable weight percent with respect to the spoilage reducing composition. In general, the functional materials are generally employed at an effective level, such level being sufficient with respect to the spoilage reducing composition, to adequately perform their function.

Coloring agent: A coloring agent may also be added to enhance the aesthetic nature of adsorbent or adsorbent packaging. It may also be added to enhance the color of the water. However, a coloring agent is not necessary. Coloring agents include, but are not limited to dyes, pigments, and polymeric colorants. Non-limited examples of dyes include acid blue 9 dye, methylene blue, and wool violet. Examples of pigment are hematite, Cu-phthalocyanine or Ultramarine blue. Examples of polymeric colorants are various products under the Liquitint™ name produced by Milliken Chemical.

Packaging Means: Suitable impermeable packaging means include, for example, but are not limited to containers of glass, plastic, waxed paper, and other materials known in the art for storing and dispensing liquid products. Other suitable impermeable packaging means include but are not limited to containers or film composed of glass, polyvinylchloride (PVC), cellulose, cellophane, thermoplastics, silicones, polyethylene, or polypropylene.

Safety is one major advantage of the present invention over other inventions. Since the present invention uses solid insoluble compounds to achieve the algae control, no compounds are released into the water, and the water is inherently safe for drinking by wildlife and pets, and safe for children to contact.

Long-lasting performance is another advantage of the present invention over other inventions. Because there are no compounds to be consumed, one is able to continually and sustainably remove micronutrients and continually prevent algae growth over a long period of time.

Low-maintenance is another advantage of the present invention over other inventions. Since these adsorbing compounds can be formed into solid objects, they do not need to be filtered or removed from the water during maintenance and cleaning. This makes preventing algal growth in a water feature virtually maintenance free.

In addition to preventing the growth of algae, under the proper circumstances the present invention can also be used to kill existing algal growth by starving it of micronutrients. If algae is already growing, depleting the water of micronutrients has been shown to stop and then kill the existing growth.

The length of time that algae is inhibited or prevented will vary due to a number of factors, for example water temperature, amount of additional water added, chemistry of the water, amount of foreign material that enters the feature, and the amount of adsorbent used. Since after some extended time period the algae may grow back, we can also describe the invention as inhibiting the growth of algae, mitigating the growth of algae, repressing the growth of algae, or other similar terms.

The invention can be used in still or recirculating water features of all types, including bird baths, water fountains, artificial streams, ornamental waterfalls, and small ponds. This same invention can also be used for non-ornamental closed-loop water systems, both static and recirculating.

The invention is not restricted to ornamental water features, can could be used in animal water troughs, live fish wells, ponds, and any other small artificial body of water that is a closed water system.

The invention describes the reduction of any transition metal micronutrient to control the growth of algae. A substantial reduction of one essential micronutrient even if needed at very low levels, can control the growth of algae. One embodiment of the invention is the reduction of one or more micronutrient metals in the D-block of the periodic table to control algae. Also, since several species of algae may be present, the invention also describes the reduction of several micronutrients, intended to control the growth of one algae or several different algae species.

Some micronutrients are needed at higher levels than others. One embodiment of the invention is the reduction of transition elements from the 4th row of the D-block in the periodic table to inhibit or prevent the growth of algae. One embodiment of the invention, is the reduction of one or more of the elements chromium, manganese, iron, cobalt, nickel, copper, zinc, and molybdenum to inhibit or prevent the growth of algae. One embodiment of the invention is the reduction of one or more of the elements manganese, iron, nickel, and molybdenum to inhibit or prevent the growth of algae. One embodiment of the invention, is the reduction of nickel to inhibit or prevent the growth of algae. One embodiment of the invention, is the reduction of manganese to inhibit or prevent the growth of algae. One embodiment of the invention, is the reduction of molybdenum to inhibit or prevent the growth of algae. One embodiment of the invention, is the reduction of iron to inhibit or prevent the growth of algae.

One can attempt to use macronutrients to create a nutrient deficiency for algae. For example, depriving algae of macronutrients such as nitrogen, potassium, or phosphorous may also limit growth. This invention may have the tangential effect of reducing macronutrients as well. However micronutrients and especially the transition metals have advantages that the other macronutrients don't. If macronutrients were the target of reduction, some issues are: 1) because of the greater quantity of the macronutrients naturally present, a greater quantity of molecules need to be adsorbed, requiring greater amounts of adsorbent, 2) the macronutrients are more common in nature and in the dust and bird waste that may fall into the feature, so they are constantly being re-introduced into the feature at a greater rate than the micronutirents; and 3) many of the macronutrients do not bind as strongly with adsorbents, and therefore are not completely removed from the system. Since micronutirents 1) occur in lower concentrations in nature, and 2) generally have greater affinity of adsorption, we can conclude that using transition metal micronutrients to control algal growth is a separate and superior strategy than using macronutrients to control algae.

The invention can be practiced in many physical forms. The adsorbents can be placed into the ornamental water feature alone without any additional packaging or enclosure. For example the adsorbent combined with bonding materials can be manufactured into a porous form shaped and colored like an animal to sit at the bottom of a bird bath. If the adsorbent is granular material, it can be easily added or removed from the feature by constraining it within a permeable enclosure. Any enclosure should be permeable for water to exchange between the adsorbent and the water exterior to the enclosure. The enclosure can be of made in various styles and types, constructed from multiple types of materials. For example the adsorbent can be enclosed within a mesh bag, a plastic container with holes, a plastic container made from plastic mesh, or a decorative container with holes. Examples of decorative containers are a shell shape, heart shape, or a turtle shape. The adsorbent can also be enclosed in a floating permeable container, for example a plastic fish, duck or other animal which freely floats around the surface of the water in a fountain. Or it can be physically bonded to the outside of another functional or decorative object to hold it in place in the water feature.

The length of time that algae is inhibited or prevented will vary due to a number of factors, for example water temperature, amount of additional water added, chemistry of the water, amount of foreign material that enters the feature, and the amount of adsorbent used. Since after some extended time period the algae may grow back, we can also describe the invention as inhibiting the growth of algae, mitigating the growth of algae, repressing the growth of algae, or other similar terms.

The attached drawings describe some of the embodiments of the invention.

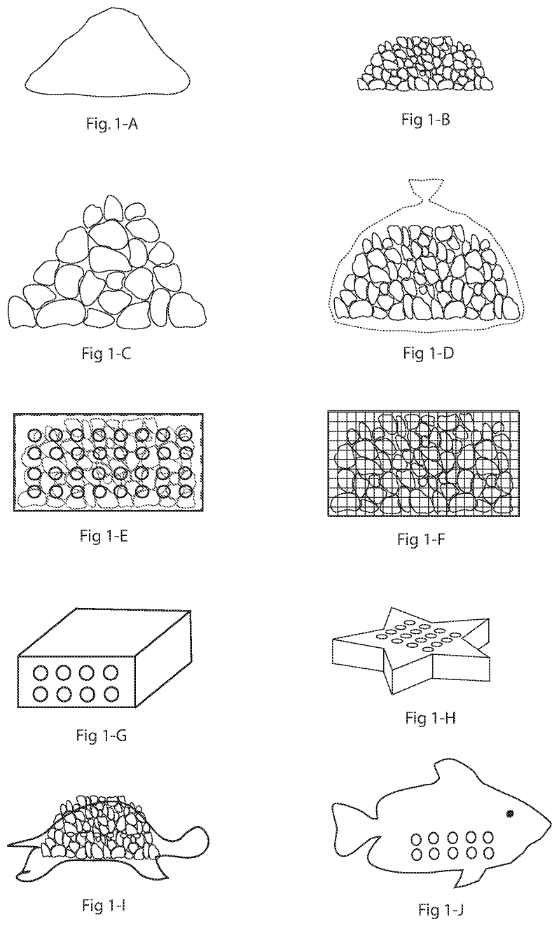

FIG. 1-A is a representative drawing showing a powdered form of the insoluble adsorbent used for control of algae as described in the present invention. FIG. 1-B is a representative drawing showing a granular form of the insoluble adsorbent used for control of algae as described in the present invention. FIG. 1-C is a representative drawing showing a large granular form of the insoluble adsorbent used for control of algae as described in the present invention. FIG. 1-D is a representative drawing showing a cross section of the granular form of the insoluble adsorbent enclosed in a flexible water permeable mesh sack, used for control of algae as described in the present invention. The mesh sack could sit on the bottom of the feature, or hang from any area in the body of water of the feature. FIG. 1-E is a representative drawing showing the granular form of the insoluble adsorbent enclosed in a rigid water-permeable container, possessing holes for water transfer, used for control of algae as described in the present invention. FIG. 1-F is a representative drawing showing the granular form of the insoluble adsorbent enclosed in a rigid water-permeable container, possessing plastic mesh for water transfer, used for control of algae as described in the present invention. FIG. 1-G is a representative drawing showing a solid block of the insoluble adsorbent used for control of algae as described in the present invention, containing holes to increase the outside surface and increase the surface contact with the water. In one embodiment of the invention, the solid block could be comprised of smaller particles of adsorbent bonded together. FIG. 1-H is a representative drawing showing a solid form of the insoluble adsorbent, bonded together in a decorative pattern, used for control of algae as described in the present invention. The form contains holes to increase the outside surface and increase the surface contact with the water. In one embodiment of the invention, the solid block could be comprised of smaller particles of adsorbent bonded together. FIG. 1-I is a representative drawing showing a granular form of the adsorbent attached to the outside of a decorative item, used for control of algae as described in the present invention. In one embodiment of the invention, the decorative item could be placed on the bottom of the body of water of the feature. FIG. 1-J is a representative drawing showing a decorative enclosure for the insoluble adsorbent in the shape of a fish, used for control of algae as described in the present invention. The enclosure contains trapped air or low density material for buoyancy to allow the decorative device to freely float on the upper part of the body of water, and holes or mesh allow the device to exchange water with the adsorbent.

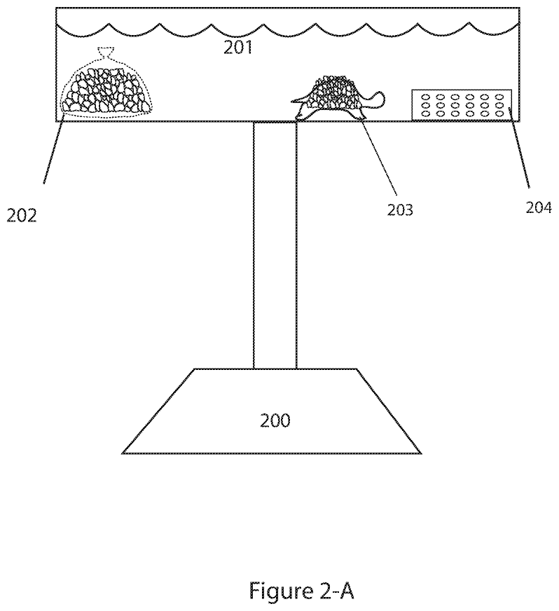

FIG. 2-A is a representative drawing showing use of the adsorbent material and enclosures in a representative type of water feature, used for control of algae as described in the present invention. This includes the granular form of the insoluble adsorbent enclosed in a flexible water permeable mesh sack 202, a representative drawing showing a granular form of the adsorbent attached to the outside of a decorative item 203, and a solid block of the insoluble adsorbent, containing water exchanges holes 204.

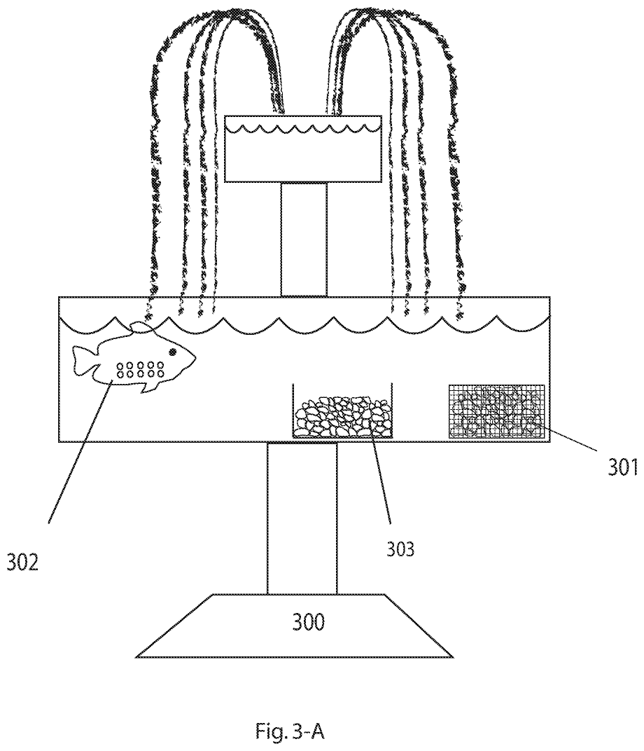

FIG. 3-A is a representative drawing showing use of the adsorbent material and enclosures in another representative type of water feature, used for control of algae as described in the present invention. This includes the granular form of the insoluble adsorbent enclosed in a rigid water-permeable container, possessing plastic mesh for water transfer 301, a decorative enclosure for the insoluble adsorbent in the shape of a fish containing trapped air or low density material for buoyancy to allow the decorative device to freely float on the upper part of the body of water, and holes or mesh allow the device to exchange water with the adsorbent 302, and the insoluble adsorbent constrained by gravity within an open container 303.

One embodiment of the invention is a method for safely preventing algae from growing in an ornamental water feature which comprises reducing the concentration of one or more of the algae transition metal micronutrients to less than the concentration needed for algae to grow, by immersing in the water an effective amount of an insoluble adsorbent capable of adsorbing transition metals.

One embodiment of the invention is a method for safely preventing algae from growing in an ornamental water feature which comprises: reducing the concentration of one or more of the algae transition-metal micronutrients to less than the concentration needed for algae to grow, by immersing in the water an effective amount of an insoluble adsorbent with a surface area of >25 m2/g and a metal binding site density of >1.0 mMol per kg.

One embodiment of the invention is a method for safely preventing algae from growing in an ornamental water feature which comprises: (a) providing an ornamental water feature filled with water; (b) providing an effective amount of an insoluble adsorbent capable of adsorbing and removing transition metals from water, to reduce the concentration of one or more of the algae transition-metal micronutrients to less than the concentration needed for algae to grow or thrive, and c) placing the insoluble adsorbent in the water to reduce the concentration of one or more of the algae transition-metal micronutrients.

One embodiment of the invention is a method for safely preventing algae from growing in an ornamental water feature which comprises: (a) providing an ornamental water feature filled with water; (b) providing an effective amount of an insoluble solid with a surface area of >25 m2/g and metal binding site density of >1.0 mMol per kg, to remove transition metals from water, and reduce the concentration of one or more of the algae transition-metal micronutrients to less than the concentration needed for algae to grow, and (c) immersing (b) into the water of (a).

One embodiment of the invention is a method for safely preventing algae from growing in an ornamental water feature which comprises: (i) providing an ornamental water feature filled with water; (ii) providing an effective amount of a solid algae-preventing composition placed within the water, said algae-preventing composition containing an insoluble adsorbent capable of adsorbing transition metals from water to reduce the concentration of one or more of the essential metal micronutrients to less than the concentration needed for algae to grow.

One embodiment of the invention is a method for safely preventing algae from growing in an ornamental water feature which comprises: (i) providing an ornamental water feature filled with water; (ii) providing an effective amount of a solid algae-preventing composition placed within the water, said algae-preventing composition containing: (a) an insoluble solid with a surface area of >25 m2/g surface area, and metal binding site density of >1.0 mMol per kg, to remove transition metals from water and reduce the concentration of one or more of the essential metal micronutrients to less than the concentration needed for algae to grow, (b) optionally, a colorant, (c) optionally, a functional additive, and (e) optionally, a water-permeable container to enclose the adsorbent.

One embodiment of the invention is a method for safely preventing algae from growing in an ornamental water feature which comprises: (i) providing an ornamental water feature filled with water; (ii) providing an effective amount of a solid algae-preventing composition placed within the water, which removes transition metals from water and reduces the concentration of one or more of the essential metal micronutrients to less than the concentration needed for algae to grow, said algae-preventing composition containing; (a) an insoluble adsorbent capable of adsorbing transition metals, (b) optionally, a colorant, (c) optionally, a functional additive, and (e) optionally, a water-permeable container to enclose the adsorbent.

One embodiment of the invention is a method for safely preventing algae from growing in an ornamental water feature which comprises: (i) providing an ornamental water feature filled with water; (ii) providing an effective amount of a solid algae-preventing composition placed within the water, which removes transition metals from water and reduces the concentration of one or more of the essential metal micronutrients to less than the concentration needed for algae to grow, said algae-preventing composition containing; (a) an insoluble solid with a surface area of >25 m2/g surface area, and metal binding site density of >1.0 mMol per kg, (b) optionally, a colorant, (c) optionally, a functional additive, and (e) optionally, a water permeable container to enclose the adsorbent.

One embodiment of the invention is a method for safely preventing algae from growing in an ornamental water feature which comprises:

(a) providing an ornamental water feature filled with water; and (b) providing an effective amount of an insoluble adsorbent capable of removing transition metals from water, to reduce the concentration of one or more of the algae transition-metal micronutrients to below the concentration needed for algae to grow or thrive.

One embodiment of the invention is a method, wherein said insoluble adsorbent has a surface area of >25 m2/g

One embodiment of the invention is a method, wherein said insoluble adsorbent transition metal binding site density of >1.0 mMol per kg.

One embodiment of the invention is a method, wherein said insoluble adsorbent comprises a compound selected from the group consisting of activated alumina, activated bauxite, activated carbon, carbon molecular sieve, zeolite molecular sieve, polymeric molecular sieve, smectite clay, natural zeolite, synthetic zeolite, silica gel, precipitated silica, fumed silica, metal organic framework, (MOF), metal-organic polyhedrals (MOP), iron hydroxide, and manganese oxide, and mixtures thereof.

One embodiment of the invention is a method, wherein said insoluble adsorbent comprises an aluminum compound selected from the group consisting of gamma alumina, chi alumina, eta alumina, rho alumina, delta alumina, theta alumina, aluminum hydroxide, diaspore, gibbsite, activated gibbsite, bayerite, boehmite, and mixtures thereof

One embodiment of the invention is a method, wherein said insoluble adsorbent comprises a carbon compound selected from the group consisting of activated carbon, activated charcoal, acid-modified activated, alkali-modified activated carbon, surface-modified activated carbon and mixtures thereof.

One embodiment of the invention is a method, wherein said insoluble adsorbent comprises an insoluble silicate selected from the group consisting of silica gel, precipitated silica, fumed silica, natural zeolite, synthetic zeolite, glauconite, greensand, smectite clay, and mixtures thereof.

Surprisingly, since one transition metal can promote a change in valent state of another transition metal, transition metals themselves can be used to promote adsorption of another. The change in valence state can cause the target metal to become insoluble and more readily adsorbed. Therefore, one embodiment of the invention is a method, wherein said insoluble adsorbent comprises an absorbent made from or coated with manganese oxide, iron oxide, iron hydroxide, zinc or permanganate salt.

One embodiment of the invention is a method, wherein said insoluble adsorbent is an activated alumina.

One embodiment of the invention is a method, wherein said transition metal micronutrients being removed are transition metals selected from the group consisting of chromium, manganese, iron, cobalt, nickel, copper, zinc, molybdenum, and combinations thereof.

One embodiment of the invention is a method, wherein the amount of insoluble adsorbent in the water feature is between 0.001% and 20% weight % of the water.

One embodiment of the invention is a method, wherein said insoluble adsorbent occurs in a shaped body, wherein said shaped body comprises a form selected from the group consisting of a powder, a granule, a crystal, a foam, a disk, a cube, a cylinder, a rod, an ovoid, a torus, a sphere, a donut, a pyramid, a prism, a geometric solid shape, a decorative solid shape, a bonded agglomerate of particles and combinations thereof.

One embodiment of the invention is a method, wherein the insoluble adsorbent is enclosed in a decorative or non-decorative permeable container, to retain the adsorbent and allow water transfer.

One embodiment of the invention is a method, wherein the insoluble adsorbent is attached to the outside of a decorative or non-decorative object.

One embodiment of the invention is a composition for safely preventing the growth of algae in an ornamental water feature, which comprises an insoluble solid to adsorb transition metals from water and reduce the concentration of one or more of the algal transition metal micronutrients to less than the concentration needed for algae to grow, possessing a surface area of greater than 50 m3/g and a density of transition metal binding sites greater than 1 mMol per kg.

One embodiment of the invention is a composition for safely preventing the growth of algae in an ornamental water feature, which comprises:

a) an insoluble solid to adsorb transition metals from water and reduce the concentration of one or more of the algal transition metal micronutrients to less than the concentration needed for algae to grow, possessing a surface area of greater than 50 m3/g and a density of transition metal binding sites greater than 1 mMol per kg,
(b) a non-adsorbing binder material, with a surface area <50 m3g, for bridging individual particles into a bonded unit, added at a level of 0-10%,
(c) a non-adsorbing low surface area material present at a level from 0%-90 to provide permeability control, structural support, or dilution,

One embodiment of the invention is a system for safely preventing the growth of algae in an ornamental water feature, which comprises:

(a) an insoluble adsorbent which removes transition metals from water to reduce the concentration of one or more of the algal transition metal micronutrients to less than the concentration needed for algae to thrive,
(b) a unitizing material or device which constrains the adsorbent particles together while still allowing water to contact the adsorbent, selected from the group consisting of 1) a binder compound used to bridge individual particles together into a bonded unit, 2) a permeable enclosure surrounding and restraining the adsorbent particles, 3) a container holding the adsorbent in by gravity, and combinations thereof,
(c) an inert material present at a level from 0%-90 to provide permeability control, structural support, or dilution,
(d) optionally, a colorant, and;
(e) optionally, a functional additive.

One embodiment of the invention is a system, wherein said insoluble adsorbent has a surface area of >25 m2/g

One embodiment of the invention is a system, wherein said insoluble adsorbent transition metal binding site density of >1.0 mMol per kg.

One embodiment of the invention is a system, wherein said insoluble adsorbent comprises a compound selected from the group consisting of activated alumina, activated bauxite, activated gibbsite, activated carbon, carbon molecular sieve, zeolite molecular sieve, polymeric molecular sieve, smectite clay, natural zeolite, synthetic zeolite, silica gel, precipitated silica, fumed silica, metal organic framework, (MOF), metal-organic polyhedrals (MOP), iron hydroxide, and manganese oxide, and mixtures thereof.

One embodiment of the invention is a system, wherein said insoluble adsorbent comprises an aluminum compound, selected from the group consisting of activated alumina, alpha alumina, gamma alumina, chi alumina, eta alumina, rho alumina, delta alumina, theta alumina, aluminum hydroxide, diaspore, gibbsite, activated gibbsite, bayerite, boehmite, and mixtures thereof.

One embodiment of the invention is a system, wherein said insoluble adsorbent comprises a carbon compound selected from the group consisting of activated carbon, activated charcoal, acid-modified activated, base-modified activated carbon, surface-modified activated carbon and mixtures thereof.

One embodiment of the invention is a system, wherein said insoluble adsorbent comprises an insoluble silicate selected from the group consisting of silica gel, precipitated silica, fumed silica, natural zeolite, synthetic zeolite, glauconite, greensand, montmorillonite, and mixtures thereof.

Surprisingly, since one transition metal can promote a change in valent state of another transition metal, transition metals themselves can be used to promote adsorption of another. The change in valence state can cause the target metal to become insoluble and more readily adsorbed. Therefore, one embodiment of the invention is a system, wherein said insoluble adsorbent comprises an absorbent made from or coated with coated with manganese oxide, iron oxide, iron hydroxide, zinc or permanganate salt.

One embodiment of the invention is a system, wherein said insoluble adsorbent is an activated alumina.

One embodiment of the invention is a system, wherein said transition metal micronutrients being removed are transition metals selected from the group consisting of chromium, manganese, iron, cobalt, nickel, copper, zinc, molybdenum, and combinations thereof.

One embodiment of the invention is a system, wherein the amount of insoluble adsorbent is between 0.001% and 20% weight % of the water in the feature.

One embodiment of the invention is a system, wherein said insoluble adsorbent occurs in a shaped body, wherein said shaped body comprises a form selected from the group consisting of a powder, a granule, a crystal, a foam, a disk, a cube, a cylinder, a rod, an ovoid, a torus, a sphere, a donut, a pyramid, a prism, a geometric solid shape, a decorative solid shape, a bonded agglomerate of particles and combinations thereof

One embodiment of the invention is a system, wherein the insoluble adsorbent is enclosed in a permeable container to allow water transfer, the permeable container shape being either decorative or simply functional.

One embodiment of the invention is a system, wherein the insoluble adsorbent is attached to the outside of an object to allow contact with water, the object being either decorative or simply functional.

One embodiment of the invention is a kit for safely preventing the growth of algae in an ornamental water feature comprising:

(i) a solid algae-preventing composition comprising:

(a) an insoluble adsorbent which removes transition metals from water to reduce the concentration of one or more of the algal transition metal micronutrients to less than the concentration needed for algae to thrive,

(b) a unitizing material or device which constrains the adsorbent particles together while still allowing water to contact the adsorbent, selected from the group consisting of 1) a binder compound used to bridge individual particles together into a bonded unit, 2) a binder compound used to bridge individual particles together on to another object, 2) a permeable enclosure surrounding and restraining the adsorbent particles, 3) a container holding the adsorbent in by gravity, and combinations thereof,

(c) a non-adsorbing low surface area material present at a level from 0%-90% to provide permeability control, structural support, or dilution,

(d) optionally, a colorant, and;

(e) optionally, a functional additive

(ii) instruction means for installing said algae-preventing composition into the ornamental water feature.

One embodiment of the invention is a kit, wherein said insoluble adsorbent comprises a compound selected from the group consisting of activated alumina, activated gibbsite, activated carbon, carbon molecular sieve, zeolite molecular sieve, polymeric molecular sieve, smectite clay, natural zeolite, synthetic zeolite, silica gel, precipitated silica, fumed silica, metal organic framework, (MOF), metal-organic polyhedrals (MOP), iron hydroxide, and manganese oxide, and mixtures thereof.

One embodiment of the invention is a kit, wherein said insoluble adsorbent comprises an aluminum compound, selected from the group consisting of activated alumina, alpha alumina, gamma alumina, chi alumina, eta alumina, rho alumina, delta alumina, theta alumina, aluminum hydroxide, diaspore, gibbsite, activated gibbsite, bayerite, boehmite, and mixtures thereof.

One embodiment of the invention is a kit, wherein said insoluble adsorbent comprises a carbon compound selected from the group consisting of activated carbon, activated charcoal, acid-modified activated, base-modified activated carbon, surface-modified activated carbon and mixtures thereof.

One embodiment of the invention is a kit, wherein said insoluble adsorbent comprises an insoluble silicate selected from the group consisting of silica gel, precipitated silica, fumed silica, natural zeolite, synthetic zeolite, glauconite, greensand, montmorillonite and mixtures thereof.

Surprisingly, since one transition metal can promote a change in valent state of another transition metal, transition metals themselves can be used to promote adsorption of another. The change in valence state can cause the target metal to become insoluble and more readily adsorbed. Therefore, one embodiment of the invention is a kit, wherein said insoluble adsorbent comprises an absorbent made from or coated with coated with manganese oxide, iron oxide, iron hydroxide, zinc or permanganate salt.

One embodiment of the invention is a kit, wherein said transition metal micronutrients being removed are transition metals selected from the group consisting of chromium, manganese, iron, cobalt, nickel, copper, zinc, molybdenum, and combinations thereof.

One embodiment of the invention is a kit, wherein the amount of insoluble adsorbent is between 0.001% and 20% weight % of the water in the feature.

One embodiment of the invention is a kit, wherein said insoluble adsorbent occurs in a shaped body, wherein said shaped body comprises a form selected from the group consisting of a powder, a granule, a crystal, a foam, a disk, a cube, a cylinder, a rod, an ovoid, a torus, a sphere, a donut, a pyramid, a prism, a geometric solid shape, a decorative solid shape, a bonded agglomerate of particles and combinations thereof.

One embodiment of the invention is a kit, wherein the insoluble adsorbent is enclosed in a permeable container to allow water transfer, the porous container shape being either decorative or simply functional.

One embodiment of the invention is a kit, wherein the insoluble adsorbent is attached to the outside of an object to allow contact with water, the object being either decorative or simply functional.

### EXAMPLES

For prototype testing, an inoculation medium, designated as ALG-1 was prepared by mixing the samples from several bird baths having algal growth, to represent a variety of microorganism.

For these examples, the level algae growth was determined visibly, as would a consumer with an algal growth problem.

### Example 1

Two 1 gallon shallow cement bird baths were filled with water and inoculated with 5 ml of ALG-1. Unit 1 was used as a control, and Unit 2 was treated by adding a polyester mesh bag of 37 g of 14×28 mesh granular activated alumina. Both units were exposed to sun, and the average daytime temperature was approximately 70 degrees. After 3 weeks, the bottom of Unit 1 was covered in brown algae, while Unit 2 was clear. The dissolved iron in Unit 1 tested as 50 ppb, while dissolved iron in Unit 2 was below detection level.

### Example 2

A deep 3 gallon glazed ceramic bird bath was monitored until the water was green with algae. It was then re-filled but not cleaned, allowing a ring of algae to remain on the side of the bird bath. 50 g of spherical activated alumina was placed in a porous mesh bag and then placed on the bottom of the bird bath. The average daytime temperature was approximately 70 degrees. The bird bath was visually monitored. The algae remaining on the side but did not grow, and within 2 days had started to turn brown. After 5 days all the algae had died, turned brown, and then decomposed. The bird bath was re-filled with new water and the alumina left in. No new algae growth started, and the bird bath at 21 days was still algae-free.

The chart below documents the results

| | |
|---|---|
| Day 0 | Bird Bath containing algae, filled and alumina placed under |
| | water. |
| Day 2 | Algae turning brown |
| Day 5 | Algae all dead and spontaneously falling off side; Refilled with |
| | tap water |
| Day 7 | No trace of algae, Remained clear and clean |
| Day 14 | No trace of algae, Remained clear and clean |
| Day 21 | No trace of algae, Remained clear and clean |

### Example 3

A three tiered 5 gallon cement fountain with green and black algae was emptied and sprayed with water, and refilled. 500 grams of granular activated alumina was split into 5 porous plastic mesh bags and placed in the top tier of the fountain. The fountain ran and remained algae-free for 4 weeks.

I claim:

1. A method for safely preventing algae from growing in an ornamental water feature which comprises: (a) providing an ornamental water feature filled with water; and (b) providing an insoluble adsorbent capable of removing transition metals from water, and (c) placing the insoluble adsorbent in the water in order to reduce the concentration of one or more algae transition-metal micronutrients.

2. A method of claim 1, where the insoluble adsorbent is added at a dosage rate of 0.1% to 20% by weight.

3. The method of claim 1, wherein said insoluble adsorbent comprises an adsorbent compound selected from the group consisting of activated alumina, activated carbon, carbon molecular sieve, zeolite molecular sieve, polymeric molecular sieve, bauxite, activated bauxite, metal organic framework, (MOF), metal-organic polyhedrals (MOP), iron hydroxide, manganese oxide, and mixtures thereof.

4. The method of claim 1, wherein said insoluble adsorbent comprises an aluminum compound selected from the group consisting of gamma alumina, chi alumina, eta alumina, rho alumina, delta alumina, theta alumina, aluminum hydroxide, diaspore, gibbsite, activated gibbsite, bayerite, boehmite, and mixtures thereof

5. The method of claim 1, wherein said insoluble adsorbent comprises a carbon compound selected from the group consisting of activated carbon, activated charcoal, acid-modified activated carbon, alkali-modified activated carbon, surface-modified activated carbon and mixtures thereof.

6. The method of claim 1, wherein said insoluble adsorbent comprises an insoluble silicate selected from the group consisting of precipitated silica, fumed silica, natural zeolite, synthetic zeolite, glauconite, greensand, and mixtures thereof

7. The method of claim 1, wherein said insoluble adsorbent is coated with a transition metal compound selected from the group consisting of manganese oxide, iron oxide, iron hydroxide, zinc salt, permanganate salt, and combinations thereof.

8. The method of claim 1, wherein said transition metal micronutrients being removed are transition metals selected from the group consisting of chromium, manganese, iron, cobalt, nickel, copper, zinc, molybdenum, and combinations thereof.

9. The method of claim 1, wherein said insoluble adsorbent occurs in a shaped body, wherein said shaped body comprises a form selected from the group consisting of a powder, a granule, a crystal, a foam, a disk, a cube, a cylinder, a rod, an ovoid, a torus, a sphere, a donut, a pyramid, a prism, a geometric solid shape, a decorative solid shape, a bonded agglomerate of particles and combinations thereof.

10. The method of claim 1, wherein the insoluble adsorbent is enclosed in a decorative or non-decorative permeable container, to retain the adsorbent and allow water transfer

11. A system for safely preventing the growth of algae in an ornamental water feature, which comprises:
(a) an insoluble adsorbent which removes transition metals from water to reduce the concentration of one or more of the algal transition metal micronutrients
(b) a material which constrains the adsorbent particles together while still allowing water to contact the adsorbent, selected from the group consisting of 1) a binder compound used to bridge individual particles together into a bonded unit, 2) a permeable enclosure surrounding the adsorbent particles, 3) a container holding the adsorbent in by gravity, and combinations thereof,
(c) an inert material present at a level from 0%-90 to provide permeability control, structural support, or dilution.

12. The system of claim 11, where the insoluble adsorbent is added at a dosage rate of 0.1% to 20% by weight.

13. The system of claim 11, wherein said insoluble adsorbent comprises an adsorbent compound selected from the group consisting of activated alumina, activated carbon, carbon molecular sieve, zeolite molecular sieve, polymeric molecular sieve, bauxite, activated bauxite, metal organic framework, (MOF), metal-organic polyhedrals (MOP), iron hydroxide, and manganese oxide, and mixtures thereof.

14. The system of claim 11, wherein said insoluble adsorbent comprises an aluminum compound, selected from the group consisting of gamma alumina, chi alumina, eta alumina, rho alumina, delta alumina, theta alumina, aluminum hydroxide, diaspore, gibbsite, activated gibbsite, bayerite, boehmite, and mixtures thereof.

15. The system of claim 11, wherein said insoluble adsorbent comprises a carbon compound selected from the group consisting of activated carbon, activated charcoal, acid-modified activated carbon, alkali-modified activated carbon, surface-modified activated carbon and mixtures thereof.

16. The system of claim 11, wherein said insoluble adsorbent comprises an insoluble silicate selected from the group consisting of precipitated silica, fumed silica, natural zeolite, synthetic zeolite, glauconite, greensand, and mixtures thereof.

17. The system of claim 11, wherein said insoluble adsorbent is coated with a transition metal compound selected from the group consisting of manganese oxide, iron oxide, iron hydroxide, zinc salt, permanganate salt, and combinations thereof.

18. The system of claim 11, wherein said transition metal micronutrients being removed are transition metals selected from the group consisting of chromium, manganese, iron, cobalt, nickel, copper, zinc, molybdenum, and combinations thereof.

19. The system of claim 11, wherein said insoluble adsorbent occurs in a shaped body, wherein said shaped body comprises a form selected from the group consisting of a powder, a granule, a crystal, a foam, a disk, a cube, a cylinder, a rod, an ovoid, a torus, a sphere, a donut, a pyramid, a prism, a geometric solid shape, a decorative solid shape, a bonded agglomerate of particles and combinations thereof

20. The system of claim 11, wherein the insoluble adsorbent is enclosed in a decorative or non-decorative permeable container, to retain the adsorbent and allow water transfer.
